(19) United States
(12) Patent Application Publication
(10) Pub. No.: US 2009/0188894 A1
(43) Pub. Date: Jul. 30, 2009

(54) WELDING GUIDE NOZZLE INCLUDING NOZZLE TIP FOR PRECISION WELD WIRE POSITIONING

(75) Inventors: Brian G. Baughman, Phoenix, AZ (US); Tom Murray, Chandler, AZ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc., Morristown, NJ (US)

(21) Appl. No.: 12/020,894

(22) Filed: Jan. 28, 2008

(51) Int. Cl. B23H 11/00; B23K 28/00

(52) U.S. Cl. 219/69.15; 219/136

(57) ABSTRACT

A welding guide nozzle for precision weld positioning of a feedstock material in a welding system. The welding guide nozzle includes a nozzle structure defining a substantially cylindrical holding apparatus that tapers at one end to define a nozzle tip. The holding apparatus and the nozzle tip include concentric bores defined therein. An erosion resistant rod is disposed within the bore defined in the nozzle tip. The erosion resistant rod includes a bore defined therein into with the weld feedstock material is disposed. The erosion resistant material is formed of a high heat resistive material thereby permitting positioning in close proximity to a heat source.

### TECHNICAL FIELD

The present invention generally relates to the fabrication of parts and devices, and more particularly relates to a welding guide nozzle including a nozzle tip for precision weld wire positioning in processes that create parts and devices by selectively applying a feedstock material to a substrate or an in-process workpiece.

### BACKGROUND

When welding or cladding with cold wire feed processes, particularly high-energy density processes such as laser and electron beam, wire positioning may be a relatively sensitive variable. Typically, a welding guide nozzle, often referred to as a wire feed nozzle, is used to position a filler wire and feed it towards a defined deposit area. The process may be manual, automated or semi-automated whereby the filler wire is deposited or welded onto a workpiece when heated by a heating source, such as a welding torch. The welding guide nozzle is generally comprised of a substantially cylindrical portion, having a bore therein for the positioning of the filler wire. The filler wire can be fed through the welding guide nozzle manually or automatically by a controller. The cylindrical portion of the welding guide nozzle ultimately tapers down to a nozzle tip through which the filler wire passes to a location or point near the weld pool. Most welding guides of this type currently on the market are composed of copper or some other easily machinable material. The use of these materials requires that the nozzle tip remain a certain distance away from the heat source to avoid melting of the nozzle tip. This often results in incorrect wire positioning due to inherency of the filler wire to wander the further it is away from the intended final position. The end result can be a defective weld.

In many instances, in addition to feeding and positioning the filler wire, the guide nozzle is used for enhancing the straightness of the filler wire prior to deposition. This straightening of the filler wire minimizes wire wander when it travels from the exit of the nozzle tip to the weld pool. By placing the nozzle tip in very close proximity to the weld pool, the effect of wire curvature is greatly minimized. When high strength materials, such as titanium and nickel are utilized as the filler wire, due to their high amount of springiness, wire straightening can be important to establish.

Hence, there is a need for a welding apparatus for use in high heat source welding applications that includes a welding guide nozzle having an orifice for the feeding of a weld material in addition to a nozzle tip that is able to withstand the high heat of the weld heat source and weld pool, thereby minimizing nozzle erosion and increasing the life of the welding guide nozzle. In addition, there is a need for a welding apparatus that includes a means for enhancing the straightness of the weld material, such as a wire feedstock material, when used with a high heat weld source to achieve an accurate weld.

### BRIEF SUMMARY

The invention described in this disclosure supports the creation of a welding guide nozzle, and more particularly an improved nozzle tip of the welding guide nozzle that is resistant to high heat typically used during high heat deposition systems, such as laser based deposition systems.

In one particular embodiment, and by way of example only, there is provided a welding guide nozzle for precision weld positioning, the welding guide nozzle comprising: a welding guide nozzle structure and an erosion resistant rod. The welding guide nozzle structure includes a holding apparatus and a nozzle tip. The holding apparatus has a bore defined therein. The nozzle tip is comprised of a bulk material and has a bore defined therein, concentric with the bore of the holding apparatus. The erosion resistant rod is disposed within the bore defined in the nozzle tip.

In yet another embodiment, and by way of example only, there is provided a welding guide nozzle for use in a cold weld feed welding system for precision weld positioning of a weld feedstock material. The welding guide nozzle comprises a holding apparatus and a nozzle tip. The holding apparatus has a bore defined therein for positioning of the weld feedstock material. The nozzle tip is comprised of a holding block and an erosion resistant rod. The holding block is comprised of a bulk material and has a bore defined therein, concentric with the bore of the holding apparatus. The erosion resistant rod is comprised of a heat resistant material and has a bore defined therein concentric with and in fluidic communication with the bore of the holding apparatus. The erosion resistant rod is disposed within the bore defined in the nozzle tip.

In yet another embodiment, and by way of example only, there is provided a cold weld feed system for precision weld positioning of a weld feedstock material. The system comprises a heat source, a weld feed mechanism, and a positioning arm. The heat source is positioned to emit an energy stream in an energy path. The weld feed mechanism is operable to feed the weld feedstock material into the energy path and deposit the weld feedstock material onto a predetermined region to form a weld. The positioning arm is coupled to the energy stream and the weld feed mechanism. The positioning arm is positionable to align the weld feed mechanism with a targeted region to fabricate the weld by transferring the weld feedstock material from the weld feed mechanism to the targeted region in a controlled manner by melting the weld feedstock material at a deposition point and allowing it to re-solidify at the targeted region. The weld feed mechanism comprises a welding guide nozzle and a nozzle tip. The welding guide nozzle includes a holding apparatus comprised of a bulk material and having a bore defined therein. The nozzle tip has a bore defined therein concentric with the bore of the holding apparatus. The nozzle tip comprises a holding block and an erosion resistant rod. The holding block is comprised of a bulk material and has a bore defined therein. The erosion resistant rod is comprised of a material having a higher melting point than that of the bulk material forming the holding block. The erosion resistant rod has a bore defined therein and is disposed within the bore defined in the nozzle tip.

Other independent features and advantages of the preferred assemblies will become apparent from the following detailed description, taken in conjunction with the accompanying drawings which illustrate, by way of example, the principles of the inventive subject matter.

### BRIEF DESCRIPTION OF THE DRAWINGS

FIG. 1 is a perspective view of an cold weld feed system including a welding guide nozzle for feeding a weld feedstock material in cooperation with a heat source, according to an embodiment;

FIG. 2 is an enlarged view of a welding guide nozzle including a nozzle tip from the cold weld feed system of FIG. 1, which is depicted in a perspective view;

FIG. 3 is an enlarged exploded cross-sectional view of the nozzle tip of the welding guide nozzle depicted in FIG. 2 according to an embodiment;

FIG. 4 is an enlarged cross-sectional view of the nozzle tip of the welding guide nozzle depicted in FIG. 2, illustrating placement of an erosion resistant rod therein; and

FIG. 5 is an enlarged cross-sectional view of another embodiment of the nozzle tip of the welding guide nozzle depicted in FIG. 2, illustrating placement of an erosion resistant rod therein.

### DETAILED DESCRIPTION OF A PREFERRED EMBODIMENT

The following description is merely exemplary in nature and is not intended to limit the invention or the application and uses of the invention. Furthermore, there is no intention to be bound by any expressed or implied theory presented in the preceding technical field, background, brief summary or the following detailed description.

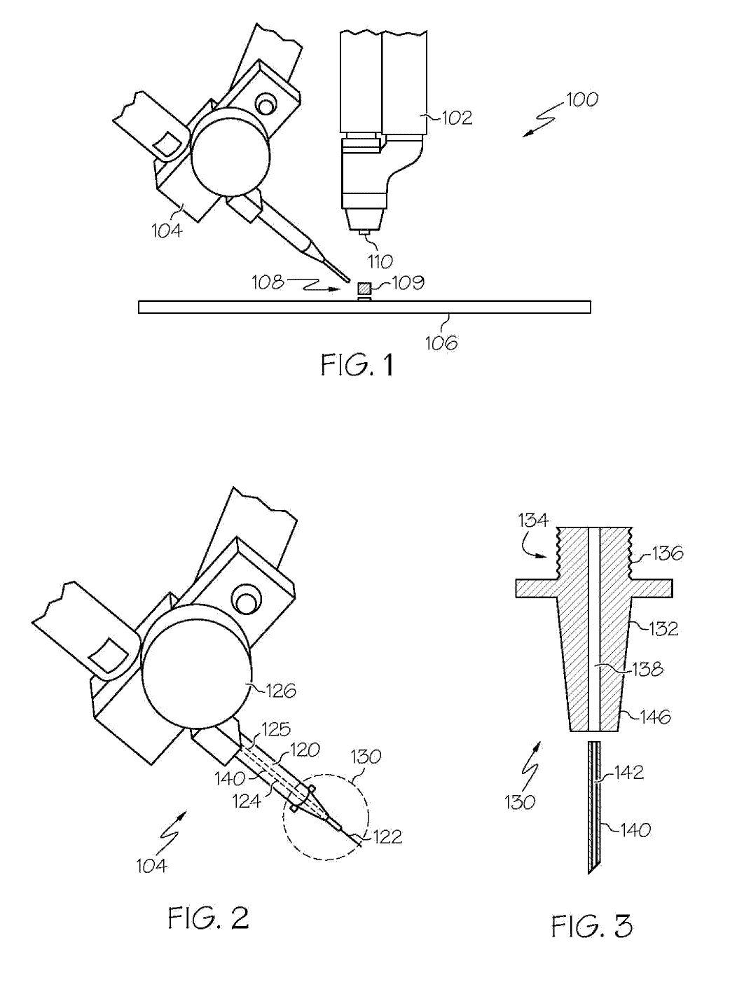

Disclosed is a weld system including an erosion resistant welding guide nozzle, and more particularly a nozzle tip of the welding guide nozzle that is capable of withstanding relatively high temperature, while maintaining heat conductivity and weld feedstock straightening properties where included, with minimal material erosion. Referring to the illustrations, FIG. 1 is a perspective view of a welding system 100, which includes a heat source 102 that functions in cooperation with a weld feed mechanism 104 to deposit the weld feed on a workpiece 106. An optional workpiece positioning system (not shown) may continuously position and reposition a platform and more particularly the workpiece 106 positioned upon the platform in a manner whereby a feedstock material may be added to the workpiece 106 through the weld feed mechanism 104 at one or more predetermined deposition points 108. Further, the workpiece positioning system may also be configured to coordinate movement and control of the heat source 102 and the wire feed mechanism 104 together with the workpiece 106 to deposit the weld feedstock material in a predictable, highly selectable, and useful manner. Control of the workpiece positioning system may be achieved by computer-implemented control software or the like. The coordinated position of the workpiece 106, the heat source 102 and the weld feed mechanism 104 provide a highly flexible, manually adaptable, and spontaneously constructible automated or semi-automated weld system through which weld depositions may be made.

The heat source 102 includes a torch nozzle 110 formed at a proximate end and having an orifice (not shown) formed therein the torch nozzle 110. A beam source, such as a laser beam, electron beam, or the like (not shown) is positioned to align with the orifice, causing a power beam to exit the torch nozzle 110 in close proximity to the workpiece 106, and more particularly at the deposition point 108. Upon being energized, the power beam exits the torch nozzle 110 in close proximity to the weld feed and toward the workpiece 106 via the orifice.

An enlarged perspective view of the weld feed mechanism 104 is depicted in detail in FIG. 2, illustrating an embodiment of the weld feed mechanism 104, including a welding guide nozzle 120. The weld feed mechanism 104, and more particularly the welding guide nozzle 120 introduces a weld feedstock 122 between the heat source 102 and the workpiece 106 (FIG. 1). The welding guide nozzle 120 includes a substantially cylindrical portion, referred to as a holding apparatus 124, having a bore 125 (shown in hidden line) therein for positioning the weld feedstock 122. The holding apparatus 124 in this particular embodiment is adjustably coupled to a positioner 126. In an alternative embodiment, the holding apparatus 124 may be fixedly coupled to the positioner 126. The positioner 126 provides for displacement of the holding apparatus 124 in an up/down and side-to-side motion relative to the workpiece 106. In addition, the positioner 126 may act as a controller to assist in feeding the weld feedstock 122 through the bore 125 of the holding apparatus 124. The cylindrical portion of the welding guide nozzle 120, and more particularly the holding apparatus 124, ultimately tapers down to a nozzle tip 130 through which the weld feedstock 122 passes to the deposition location or point 108 near the heat source 102.

Beam based systems, such as the system 100, are inherently energy diffuse due to the basic mechanism of heat transfer, and more particularly the impingement of a relatively hot beam onto the work piece 106. To prolong the life of the welding guide nozzle 120 while maintaining high deposition accuracy, the nozzle tip 130 of the welding guide nozzle 120 is preferably formed to withstand relatively high temperatures when placed near the heat source 102. With a laser based system, such as that described with respect to FIG. 1, to carry the increased heat, erosion of the welding guide nozzle 120 may occur. To prolong the life of the welding guide nozzle 120, the nozzle tip 130 is kept cool and resistant to heat. In the embodiment illustrated in FIG. 2, copper is used to fabricate the welding guide nozzle 120, and more particularly the structure defining the holding apparatus 124. To achieve an optimum combination of high heat resistance and high deposition accuracy, a high heat resistive material is used to form the nozzle tip 130. More specifically, an erosion resistant material is used to form an insert, or an erosion resistant rod 140 that serves as a guide for the weld feedstock 122 while simultaneously protecting the holding apparatus 124 from coming in contact with the heat source 102 (FIG. 1). The erosion resistant material provides for a highly erosion resistant and temperature resistant device for delivery of the weld feedstock 122 near the heat source 102. Generally speaking, the erosion resistant material is comprised of a material having a higher melting point than that of the bulk material forming the holding apparatus 124.

Referring now to FIG. 3, illustrated in an enlarged, exploded cross-sectional view is the highlighted area of FIG. 2, showing the nozzle tip 130 in further detail. The nozzle tip 130 is generally comprised of a holding block 132 including a plurality of threads 134 at a first end 136 to enable securement of the holding block 132 within an end portion of the holding apparatus 124 of FIG. 2. In this exemplary embodiment, the holding block 132 is formed of a copper material and includes a bore 138 formed therein for insertion of the erosion resistant rod 140. The erosion resistant rod 140 is formed as an electro-discharge machining (EDM) electrode and of a high heat resistive material. High heat resistance may be met by fabricating the erosion resistant rod 140 of at least one of several bulk materials including a refractory material such as tungsten, carbon, rhenium, copper, iridium, material, an alloy of a refractory material including tungsten, carbon, rhenium, copper, iridium, or a ceramic material such as silicon carbide, aluminum oxide, etc. In this particular embodiment, the erosion resistant rod 140 is formed of a tungsten carbide material that forms the bulk of the erosion resistant rod 140. The erosion resistant rod 140 includes a bore 142, concentric with the bore 125 formed in the holding apparatus 124 and having a diameter of approximately 0.002 inches larger than the weld feedstock 122, which in this particular embodiment is a weld wire (described presently). The erosion resistant rod 140 is preferably machined to approximately 1.5 inches in length and positioned within a second end 146 of the holding block 132.

As stated, in this particular embodiment the erosion resistant rod 140 is comprised of tungsten carbide. Alternatively, the erosion resistant material may be comprised of at least one of a refractory material and/or a ceramic material. Refractory materials generally consist of single or mixed high melting point oxides of elements such as rhenium, silicon, aluminum, magnesium, calcium and zirconium. Non-oxide refractory materials also exist and include materials such as carbides, nitrides, borides and graphite. Ceramic materials may include silicon carbide, aluminum oxide, or the like. Alternative examples of erosion resistant materials that may form the erosion resistant rod 140 are rhenium disposed on a copper substrate that forms a structure of the erosion resistant rod 140. This combination of materials may provide not only high bulk thermal conductivity but a more resistant erosion surface at a rod-heat source interface 109 (FIG. 1). Other alternative embodiments may include a rhenium-tungsten, molybdenum rhenium, other rhenium alloys forming the erosion resistant rod 140, or an iridium material forming the erosion resistant rod 140 with or without rhenium etc. as an under layer.

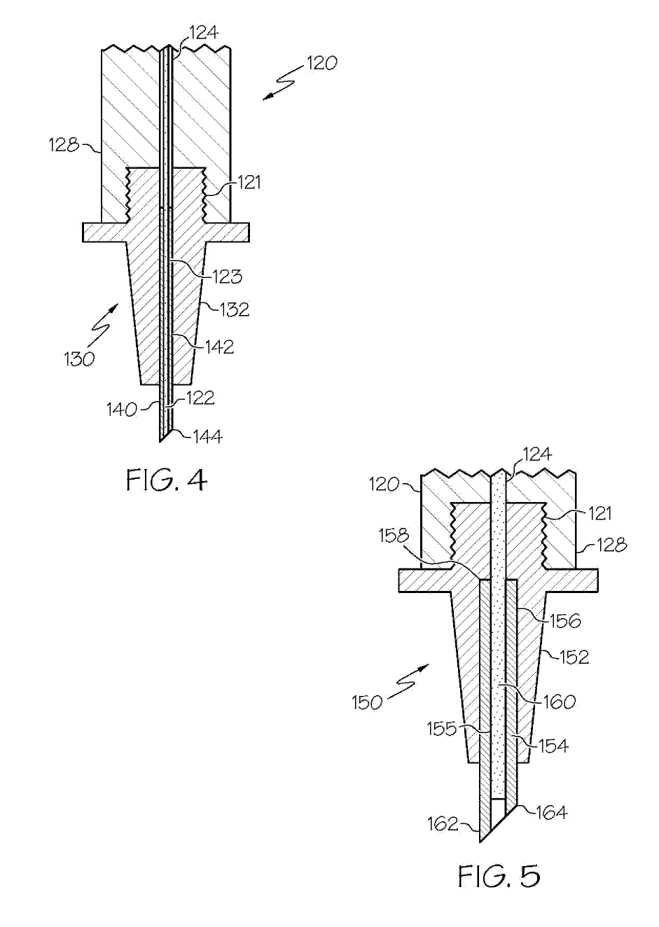

Referring now to FIG. 4, illustrated is the nozzle tip 130 positioned within an end portion 128 of the holding apparatus 124. The nozzle tip 130, and more particularly the holding block 132, is threaded into a set of reciprocating threads 121 formed in the holding apparatus 124. The erosion resistant rod 140 is positioned within the bore 138 formed in the holding block 132. In this particular embodiment, the weld feedstock 122 is a wire 123 having a diameter less than the diameter of the bore 142 of the erosion resistant rod 140. A tip 144 of the erosion resistant rod 140 is formed, typically by grinding, at an angle so that it does not interfere with a surface of the workpiece 106 and provides the ability of the tip 144 to be positioned nearer the heat source 102 (FIG. 1).

To fabricate the welding guide nozzle 120, the erosion resistant rod 140 is typically separately formed and disposed within the structure forming the welding guide nozzle 120, and more particularly the holding apparatus 124. Any intermediate layers disposed between the erosion resistant rod 140 and the holding apparatus 124 may be applied prior to positioning the erosion resistant rod 140 using chemical vapor deposition, physical vapor deposition, laser coating, electrochemical deposition, powder metallurgy techniques such as HIPing or axial loading, IFF, or any other deposition method commonly known in the art.

Referring now to FIG. 5, illustrated is a nozzle tip 150, generally similar to the nozzle tip 130 of the previous embodiment, positioned within the end portion 128 of the holding apparatus 124. In this particular embodiment, the nozzle tip 150, and more particularly a holding block 152, formed generally similar to the holding block 132 of the previous embodiment, is threaded into the set of reciprocating threads 121 formed in the holding apparatus 124. An erosion resistant rod 154 is positioned within a bore 156 formed in the holding block 152. The bore 156 is formed concentric with the bore 125 of the holding apparatus 124, and includes a shoulder 158 formed in the holding block 152 to provide a positioning stop for the erosion resistant rod 154 within the bore 156. High heat conductivity and/or high resistance to beam erosion may be met by fabricating the erosion resistant rod 150 out of at least one of several bulk materials as previously described with respect to the first embodiment. In this particular embodiment, the weld feedstock 122 is a weld powder 160 that is fed through the bores 125 and a bore 155 formed in the erosion resistant rod 154, to a tip 162 of the erosion resistant rod 154. Similar to the embodiment illustrated in FIG. 4, the nozzle tip 150, and more particularly an end portion 164 of the tip 162 of the erosion resistant rod 154, is optionally formed at an angle so that it does not interfere with a surface of the workpiece 106 (FIG. 1) and provides the ability of the tip 162 to be positioned nearer the heat source 102 (FIG. 1).

As previously identified, any material susceptible to melting by the heat source 102 (FIG. 1) may be used as the weld feedstock 122 and supplied in the form of a powder feed or wire feed using the weld feed mechanism 104. Such materials may include steel alloys, aluminum alloys, titanium alloys, nickel alloys, although numerous other materials may be used as the weld feedstock 122 depending on the desired material characteristics such as fatigue initiation, crack propagation, post-welding toughness and strength, and corrosion resistance at both welding temperatures and those temperatures at which the component onto which the weld is deposited will be used. Specific operating parameters including heat source temperatures, build materials, melt parameters, nozzle angles and tip configurations, dopants, and nozzle coolants may be tailored to fit the weld process.

Other alternative embodiments may include forming additional erosion resistant layers of other erosion resistant materials as previous described as intermediate layers disposed between the structure forming the holding apparatus 124 and the erosion resistant rod 140.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A welding guide nozzle for precision weld positioning, the welding guide nozzle comprising:
a welding guide nozzle structure, including a holding apparatus and a nozzle tip, the holding apparatus having a bore defined therein, the nozzle tip comprised of a bulk material and having a bore defined therein, concentric with the bore of the holding apparatus; and
an erosion resistant rod disposed within the bore defined in the nozzle tip.

2. The welding guide nozzle of claim 1, wherein the erosion resistant rod is comprised of a material having a higher melting point than that of the bulk material that forms the holding apparatus.

3. The welding guide nozzle of claim 2, wherein the bulk material is carbon.

4. The welding guide nozzle of claim 2, wherein the erosion resistant rod is comprised of a heat resistant material.

5. The welding guide nozzle of claim 4, wherein the heat resistant material is selected from a group consisting of a refractory material and a ceramic material.

6. The welding guide nozzle of claim 5, wherein the refractory material includes one of a single or mixed high melting point oxide of at least one of rhenium, hafnium, silicon, aluminum, magnesium, calcium, and zirconium or a non-oxide of at least one of a carbide, nitride, boride and graphite.

7. The welding guide nozzle of claim 5, wherein the ceramic material includes silicon carbide and aluminum oxide.

8. The welding guide nozzle of claim 4, wherein the heat resistant material is tungsten carbide.

9. The welding guide nozzle of claim 1, wherein the erosion resistant rod is an electro-discharge machining (EDM) electrode.

10. A welding guide nozzle for use in a cold weld feed welding system for precision weld positioning of a weld feedstock material, the welding guide nozzle comprising:
a holding apparatus having a bore defined therein for positioning of the weld feedstock material;
a nozzle tip comprised of a holding block and an erosion resistant rod, the holding block comprised of a bulk material and having a bore defined therein, concentric with the bore of the holding apparatus,
wherein the erosion resistant rod is comprised of a heat resistant material and having a bore defined therein concentric with and in fluidic communication with the bore of the holding apparatus, the erosion resistant rod disposed within the bore defined in the nozzle tip.

11. The welding guide nozzle of claim 10, wherein the heat resistant material is selected from a group consisting of a refractory material and a ceramic material.

12. The welding guide nozzle of claim 11, wherein the refractory material includes at least one of a single or mixed high melting point oxide of at least one of rhenium, silicon, aluminum, magnesium, calcium, and zirconium or a non-oxide of at least one of a carbide, a nitride, a boride and a graphite.

13. The welding guide nozzle of claim 11, wherein the ceramic material includes silicon carbide and aluminum oxide.

14. The welding guide nozzle of claim 10, wherein the heat resistant material is tungsten carbide.

15. The welding guide nozzle of claim 10, wherein the erosion resistant rod includes a heat resistant coating layer disposed as a coating on a surface of the erosion resistant rod.

16. The welding guide nozzle of claim 10, wherein the holding apparatus is cylindrical shaped and tapers at a first end to define the nozzle tip.

17. A cold weld feed system for precision weld positioning of a weld feedstock material, the system comprising:
a heat source positioned to emit an energy stream in an energy path;
a weld feed mechanism operable to feed the weld feedstock material into the energy path and deposit the weld feedstock material onto a predetermined region to form a weld; and
a positioning arm coupled to the energy stream and the weld feed mechanism, whereby the positioning arm is positionable to align the weld feed mechanism with a targeted region to fabricate the weld by transferring the weld feedstock material from the weld feed mechanism to the targeted region in a controlled manner by melting the weld feedstock material at a deposition point and allowing it to re-solidify at the targeted region;
wherein the weld feed mechanism comprises:
a welding guide nozzle, including a holding apparatus comprised of a bulk material and having a bore defined therein and a nozzle tip having a bore defined therein concentric with the bore of the holding apparatus;
wherein the nozzle tip comprises:
a holding block comprised of a bulk material and having a bore defined therein; and
an erosion resistant rod comprised of a material having a higher melting point than that of the bulk material forming the holding block, the erosion resistant rod having a bore defined therein and disposed within the bore defined in the nozzle tip.

18. The system of claim 17, wherein the material of the erosion resistant rod is selected from a group consisting of at least one of a single or mixed high melting point oxide of at least one of rhenium, silicon, aluminum, magnesium, calcium, and zirconium, or at least one of a non-oxide of a carbide, a nitride, a boride, a graphite, or at least one of a silicon carbide and an aluminum oxide.

19. The system of claim 18, wherein the erosion resistant rod is comprised of tungsten carbide.

20. The system of claim 17, wherein the weld feedstock material is one of a weld wire or a weld powder material.
